(19) United States
(12) Patent Application Publication
(10) Pub. No.: US 2022/0253569 A1
(43) Pub. Date: Aug. 11, 2022

(54) RECOMBINATION OF NUMERICAL ANALYSIS FOR IMPACT SIMULATION

(71) Applicant: Safran Seats USA LLC, Gainesville, TX (US)

(72) Inventors: Romain Tranier, Costa Mesa, CA (US); Daniel J. Boast, Cardiff (GB); Sebastien Depierre, Buxières d'Aillac (FR); Florent Masse, Bourges (FR); Mathieu Dagois, Issoudun (FR)

(21) Appl. No.: 17/612,154

(22) PCT Filed: May 31, 2019
(86) PCT No.: PCT/US2019/034904

§ 371 Date: Nov. 17, 2021

(51) Int. Cl. G06F 30/15

(52) U.S. Cl. CPC G06F 30/15; G06F 30/23

(57) ABSTRACT

Computational numerical analysis for passenger seating assemblies can be performed by generating a combined computer numerical simulation based on two or more partial numerical simulations of different assemblies and/or virtual passengers or anthropomorphic test dummies (ATDs). The partial numerical simulations may be run for a common, nonzero period of time, after which first simulation data from the first numerical simulation and second simulation data from the second numerical simulation can be captured and used for generating the combined numerical simulation. The combined numerical simulation can simulate a collision between the different assemblies and/or virtual ATDs by assembling the first and second partial simulation data such that the modeled assemblies collide in the combined computer numerical simulation. Any suitable number of combined numerical simulations in a variety of specific variations may be regenerated using the first and second partial simulation data.

### FIELD OF THE INVENTION

The field of the invention relates to methods and systems for performing computer numerical analysis for impact safety testing.

### BACKGROUND

In commercial aircraft, seats are designed to meet the needs of passenger safety and comfort, while accounting for strict limitations on weight and space. Safety criteria require not only that the seats provide adequate support for passengers, but involve extensive testing and certification against both government regulations and industry safety standards. Among safety criteria, the prevention of head injury is of paramount importance, with various structures directed to providing secure seating and mitigating passenger head impact in turbulent or impact conditions, such as emergency landings. Unlike ground-based transport, air transport must cope with limited space and weight constraints for safety devices. For these reasons, in existing aircraft structures and particularly in aircraft seating, structures are designed to manage and absorb the energy released in a crash scenario to meet and exceed passenger injury criteria. However, although real-world tests are routinely required to certify new seating designs, such testing is time-consuming and expensive. For that reason, extensive preliminary testing is performed in a virtual space using computer numerical simulation (e.g., finite-element analysis or the like). However, as virtual testing grows more extensive and widespread, the costs of data processing impose constraints on the scope and variation of computer numerical simulation that can be economically conducted. For these reasons, improvements in methods for numerical analysis for impact simulation are needed.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, a computer-implemented method of performing a computational analysis of an abrupt deceleration (e.g., in the context of a passenger craft such as an aircraft performing an emergency landing or braking) can include generating a combined computer numerical simulation based on two or more partial numerical simulations. Suitable methods can specifically include, on a computing device, generating a first numerical simulation representative of a first component and modeling a second numerical simulation representative of a second component. The first numerical simulation and the second numerical simulation can each be run for a common, nonzero period of time, after which first simulation data from the first numerical simulation and second simulation data of the second numerical simulation can be captured and subsequently used for generating a combined numerical simulation representative of the first component and the second component, positioned in a first relative orientation and at a first predetermined distance with respect to each other, based on the first simulation data and the second simulation data. The combined numerical simulation can be used for simulating a collision of the first component and the second component by the combined numerical simulation. Any suitable number of combined numerical simulations may be regenerated using the same first and second simulation data.

According to certain embodiments of the present invention, methods of simulating a passenger seating assembly can include selecting first numerical simulation data, the first numerical simulation data corresponding to a first numerical simulation of a first passenger seat having undergone translation or deformation induced by abrupt deceleration (e.g., pulse); and selecting second numerical simulation data, the second numerical simulation data corresponding to a second numerical simulation of a second passenger seat and a virtual passenger or virtual anthropomorphic test dummy (ATD) having undergone translation or deformation. The first and second numerical simulation data can be sampled for modeling, on a computing device, a combined numerical simulation based on the first numerical simulation data and second numerical simulation data. The combined numerical simulation can include a combined system of the first passenger seat, virtual passenger or virtual ATD, and the second passenger seat, with an initial condition of the combined numerical simulations including the aforementioned components having already undergone partial deformation, translation, or rotation associated with an impact, acceleration, or deceleration event.

Also disclosed are systems for modeling a passenger seating assembly in impact, acceleration, or deceleration conditions, in accordance with various embodiments of the present invention. Suitable systems can include one or more processors and memory devices storing executable instructions that, when executed by the processor, cause the processor to perform operations on the computer numerical simulation data as described above. The various processing steps disclosed herein can include receiving first numerical simulation data corresponding to a first numerical simulation of a first passenger seat having undergone acceleration for a nonzero period of time, and receiving second numerical simulation data corresponding to a second numerical simulation of a second passenger seat and a virtual passenger or virtual anthropomorphic test dummy (ATD) having undergone acceleration for the same nonzero period of time. The system can then generate a combined numerical simulation based on an initial condition and including representations of the first passenger seat, the virtual passenger or virtual anthropomorphic test dummy (ATD), and the second passenger seat having undergone acceleration for the nonzero period of time. According to various alternative embodiments, combined numerical simulations can be generated with a variety of initial conditions based on the first and second numerical simulation data without necessitating regeneration of the first and second numerical simulation data.

### BRIEF DESCRIPTION OF THE DRAWINGS

FIG. 1A is a simplified side view schematic of a virtual seating arrangement of simulated components with a virtual anthropomorphic test dummy (ATD) as modeled in a computer numerical simulation of an impact event.

FIG. 1B is a simplified side view schematic showing the simulated arrangement of FIG. 1A during the impact event, in accordance with various embodiments of the present disclosure.

FIG. 2A is a simplified side view schematic a first component of a virtual seating arrangement with a virtual anthropomorphic test dummy (ATD) as modeled in a computer numerical simulation of an impact event.

FIG. 2B is a simplified side view schematic showing the simulated component of FIG. 2A during the impact event.

FIG. 3A is a simplified side view schematic a second component of a virtual seating arrangement as modeled in a computer numerical simulation of an impact event.

FIG. 3B is a simplified side view schematic showing the simulated component of FIG. 3A during the impact event.

FIG. 4A is a simplified side view schematic showing a virtual seating arrangement assembled from the simulated components and virtual ADT of FIGS. 2B and 3B, in accordance with various embodiments of the present disclosure.

FIG. 4B is a simplified side view schematic showing the virtual seating arrangement of FIG. 4A during an impact event.

FIG. 5 is a simplified side view schematic showing an alternative virtual seating arrangement assembled using partial simulations as described with reference to FIGS. 2A-3B.

FIG. 6 is a simplified side view schematic showing a second alternative virtual seating arrangement assembled using partial simulations as described with reference to FIGS. 2A-3B.

FIG. 7 is a simplified side view schematic showing a third alternative virtual seating arrangement assembled using partial simulations as described with reference to FIGS. 2A-3B.

FIG. 8 is a simplified top view schematic showing an alternative virtual seating arrangement assembled with variations in a yaw angle with respect to the direction of simulated acceleration.

FIG. 9 illustrates a first example process for generating a combined numerical analysis for impact simulation, in accordance with various embodiments of the present disclosure.

FIG. 10 illustrates a second example process for generating a combined numerical analysis for impact simulation.

FIG. 11 illustrates an example process for iteratively generating combined numerical analyses for impact simulation.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide improved seat bottom assemblies for passenger seats. While the improved seat bottom assemblies are discussed for use with aircraft seats, they are by no means so limited. Rather, embodiments of the seat bottom assemblies may be used in passenger seats or other seats of any type or otherwise as desired.

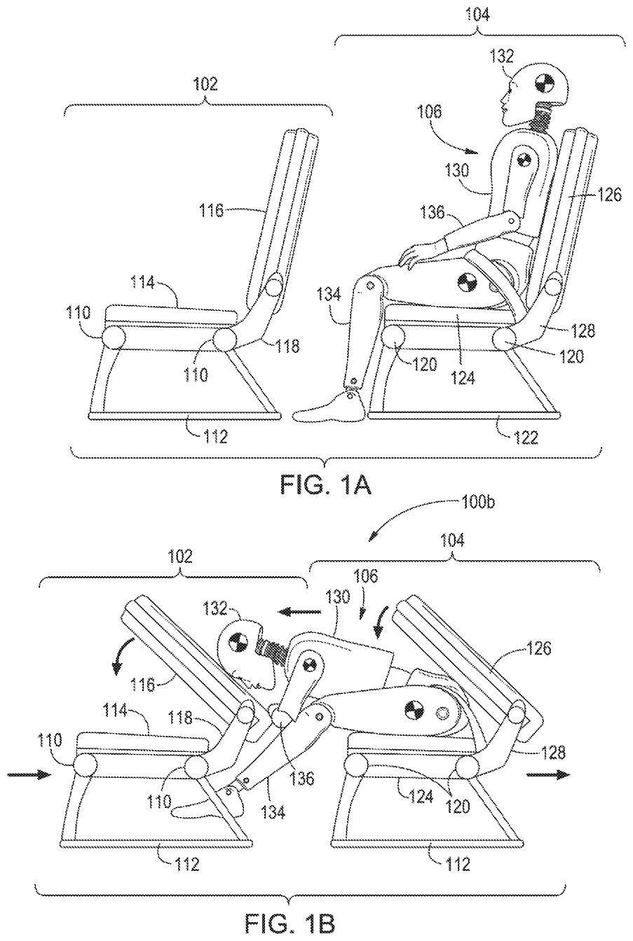

FIG. 1A-1B show a simplified example, in a side view schematic, of a computer numerical model 100a in an initial condition, and the same numerical model 100b in a final condition after an impact test. Computer numerical simulations of this type (e.g., finite-element models, or the like) can be used to model the behavior of a variety of structures and materials. In a typical numerical simulation, real-world objects are modeled as assemblies of parts, each part being broken up by software into a potentially large number of small elements connected to adjacent elements by nodes. The physical properties of the parts (e.g. bulk strength) are captured by the rules governing connections between elements. Initial conditions of the modeled structure can be obtained by setting additional constraints on the parts that translate to additional rules on their component parts (e.g., clamping stress induced on connected parts.) Useful aspects of the simulation (e.g., stress, strain) are obtained by setting initial conditions (e.g., pinning select parts to a location, and imparting force or acceleration on select parts or on the modeled structures as a whole).

FIG. 1A shows the application of computer numerical simulation to a seating arrangement that includes a first seating assembly 102 and a second seating assembly 104 aft of the first. A typical computer numerical simulation might model significantly more than two seating assemblies at one time, and may for example include models of two rows (with virtual passengers). The first seating assembly 102 includes a base 112 that supports frame tubes 110. The frame tubes 110 support spreaders 118 and a seat bottom 114, and the spreaders further support a seat back 116. Similarly, the second seating assembly 104 includes a base 122 that supports frame tubes 120. The frame tubes 120 support spreaders 128 and a seat bottom 124, and the spreaders further support a seat back 126. The second seating assembly 104 additionally supports a virtual passenger or virtual anthropomorphic test dummy (ATD) 106. The virtual ATD 106 can include a body 130, head portion 132, leg portions 134 and arm portions 136 that are arranged and assigned weight to simulate the movement of a human passenger. FIG. 1B shows the evolution of the computer numerical simulation shown in FIG. 1A after the application of acceleration to the seating assemblies 102, 104, including the effects of impact (if any) of the virtual ATD 106 on the first seating assembly 102. Although effective, the process of modeling a large number of components as in multi-seat seating arrangements is computationally demanding. Depending on the available computational power, a full-scale computer numerical simulation of an impact event for a seating assembly may take hours or days to compute from initial conditions through impact.

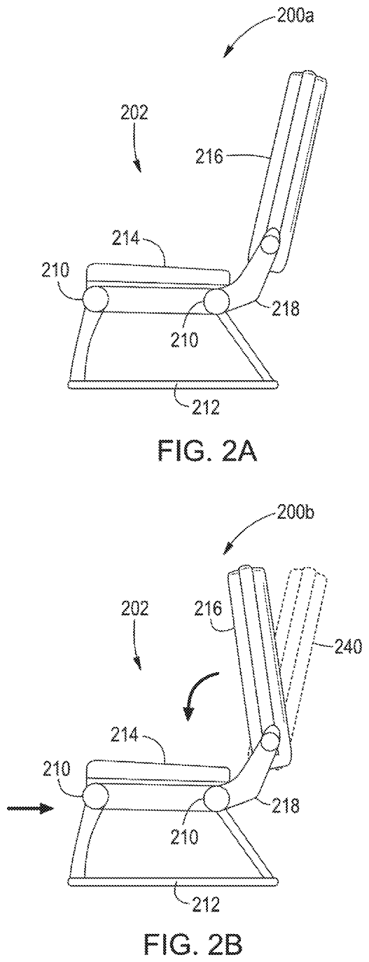

In accordance with various embodiments of the present invention, FIGS. 2A-4B schematically illustrate methods for generating recombined numerical simulations that overcome computational bottlenecks normally inherent in numerical analysis. FIG. 2A shows an example of a computer numerical simulation 200a of a first seating assembly 202 in an initial state. Seating assembly 202 includes a base 212 that supports frame tubes 210. The frame tubes 210 support spreaders 218 and a seat bottom 214, and the spreaders further support a seat back 216. According to some embodiments, the seating assembly 202 may be fixed to a frame of reference at the base 212, with other parts free to deform with respect to the base depending on the various forces applied thereto. In alternative embodiments, it will be understood that the seating assembly 202 can be fixed to a reference frame by parts other than the base 212, e.g. by the frame tubes 210, or by a combination of elements. In some embodiments, the number of modeled components may be minimized to reduce processing requirements. For example, the base 212 may be omitted, and the seating assembly 202 fixed in space by the frame tubes 210, spreader 218, or other component(s).

FIG. 2B shows an example of a first partially completed computer numerical simulation 200b resulting from the initial numerical simulation 200a having undergone simulated force or acceleration for a nonzero period of time. In the second computer numerical simulation 200b, the same elements are present as in the initial numerical simulation 200a, but have undergone deformation consistent with, e.g., an intermediate stage in a rapid deceleration event. The degree of deformation will depend on the severity of the simulated event and the amount of elapsed time. The amount of elapsed time is selected to correspond to an expected amount of time required for a passenger (or virtual passenger, or virtual ATD) to impact with the first seating assembly 202, or alternatively to approach without impacting the first seating assembly. In some embodiments, the amount of elapsed time is selected to correspond to an expected amount of time required for a virtual passenger or virtual ATD to interact with an original position 240 of the first seating assembly 202.

The virtual position 240 can be a volume corresponding to the entire structure of the first seating assembly 202 modeled in the initial numerical simulation 200a. According to some embodiments, the virtual position 240 may be simplified to capture a surface or plane corresponding to one or more parts of the seating assembly 202 (e.g., a plane demarking an original position of a rearmost portion of the seat back 216, a volume corresponding to the seat back and/or adjacent features, or a surface corresponding to the seat back and/or adjacent features, which may be an irregular surface).

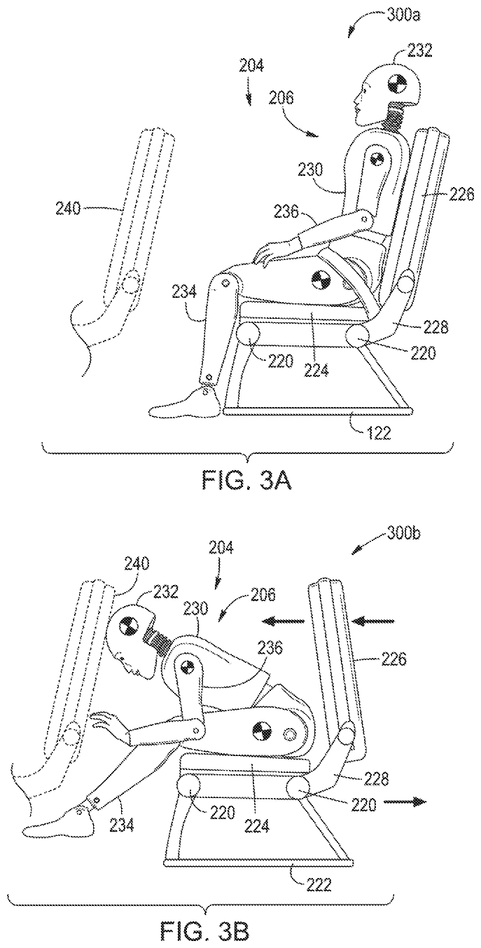

FIG. 3A shows an example of a second initial computer numerical simulation 300a of a second seating assembly 204 and virtual passenger or virtual ATD 206 in an initial state. Seating assembly 204 includes a base 222 that supports frame tubes 220. The frame tubes 220 support spreaders 228 and a seat bottom 224, and the spreaders further support a seat back 226. The aforementioned features may have similar dimensions to or may differ from those of the first seating assembly 202 (i.e., may be different instances of the same seat, or may be different seats having different dimensions). According to some embodiments, the seating assembly 202 may be fixed to a frame of reference at the base 222, with other parts free to deform with respect to the base depending on the various forces applied thereto. In alternative embodiments, it will be understood that the seating assembly 202 can be fixed to a reference frame by parts other than the base 222, e.g. by the frame tubes 220, or by a combination of elements. In some embodiments, the number of modeled components may be minimized to reduce processing requirements. For example, the base 222 may be omitted, and the seating assembly 202 fixed in space by the frame tubes 220, spreader 228, or other component(s).

The second initial computer numerical simulation 300a may also include a virtual passenger or virtual ATD 206. A “virtual ATD” may refer to any suitable computer numerical model that simulates a passenger, and may be simplified to model specific behaviors, may be sufficiently complex to provide a robust stand-in for an actual passenger, or may be specifically modeled to capture the features of a physical ADT in a physical acceleration- or impact-testing apparatus that may be used to validate the computer numerical models. A virtual ATD 206 can include a body 230, a head portion 232, leg portions 234 and arm portions 236 connected with the body 230. According to various embodiments, the specific accelerations, velocities, and forces exerted on each portion of the virtual ATD 206 can be extracted from the computer numerical model. Specific elements or nodes within the ATD can be flagged to provide information about the exact accelerations, velocities, and forces exerted on particular components of the ATD during simulation, and some or all such elements or nodes may be selected or positioned to match locations of physical monitoring (e.g., accelerometer placement) in a physical ATD. The virtual ATD 206 may be positioned within the initial computer numerical simulation 300a in a position on the seating assembly 203 consistent with that of a seated passenger, which may or may not include being buckled to the seating assembly by a lap belt or other suitable device.

The second initial computer simulation 300a may include information that corresponds to a limit of the range-of-motion permitted during the initial simulation such as, but not limited to, virtual position 240 that corresponds to an expected location of a paired structure (e.g., seating assembly 202 of FIG. 2A). Virtual position 240 can be extracted from the first computer numerical simulation 200b. Although the paired structure is not present in the second initial computer simulation 300a, information concerning its ultimate disposition with respect to the second seating assembly 204 can be used to, e.g., determine a stopping point for the initial computer simulations 200a, 300a, or to set a common time interval at which to either halt the numerical simulations 200b, 300b (FIG. 3B), or from which to extract state data from the computer simulations for use in a combined numerical simulation.

FIG. 3B shows an example of a second partially completed computer numerical simulation 300b resulting from the initial numerical simulation 300a having undergone simulated force or acceleration for a nonzero period of elapsed time. In the second computer numerical simulation 300b, the same elements are present as in the initial numerical simulation 300a, but have undergone deformation consistent with, e.g., an intermediate stage in a rapid deceleration event. The degree of deformation will depend on the severity of the simulated event and the amount of elapsed time. According to some embodiments, the amount of elapsed time can be selected to correspond to an expected amount of time required for the virtual ATD 206 to interact with the virtual position 240, i.e., the computer numerical simulation 300b can be halted at such time as an overlap exists between the virtual ADT 206 and the virtual position 240.

Alternatively, the amount of elapsed time can be selected based on the time at which other criteria are met, e.g., the interaction of any element of the second computer numerical simulation 300b with any portion of the virtual position 240, or a time at which any element of the second computer numerical simulation 300b exceeds a stress limit or other structural criterion. In some embodiments, the amount of elapsed time is selected to correspond to an expected amount of time required for a virtual passenger or virtual ATD to interact with an original position 240 of the first seating assembly 202, where the expected amount of time is based on a simplified analysis (e.g., a simplified physical model), a manual input based on preexisting data, or a modification of a calculated amount of elapsed time for the addition of a safety factor or other suitable adjustment. According to some embodiments, the second computer numerical simulation 300b can be run for an arbitrary duration, and state data can be captured based on a suitable elapsed time as described above.

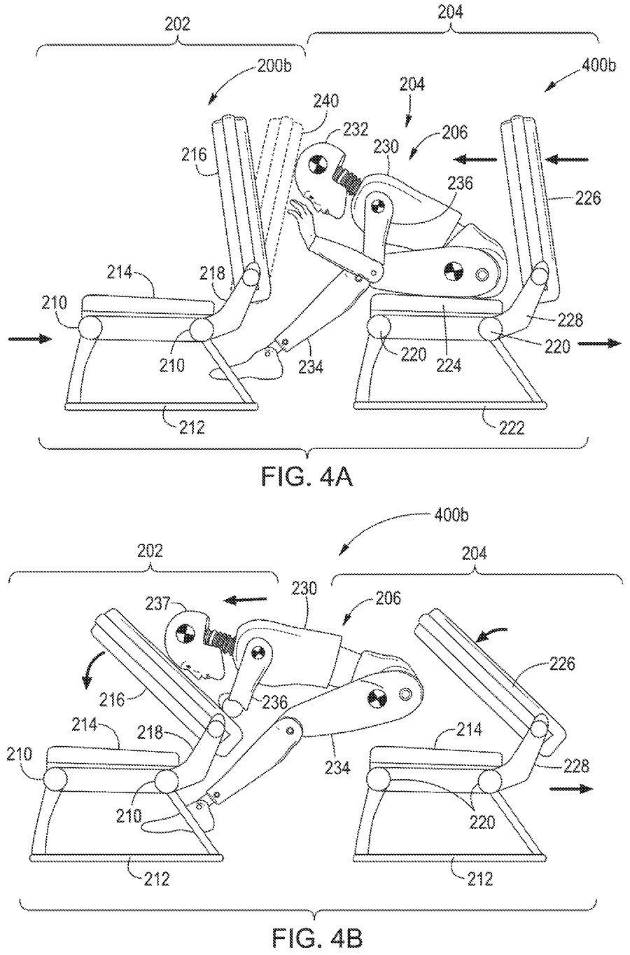

The state data captured from each of the partially complete numerical simulations 200b, 300b, can be combined to generate an initial state of a combined numerical simulation 400a, as shown in FIG. 4A. In one embodiment, the combined numerical simulation 400a can include, e.g., a first seating assembly 202 and a second seating assembly 204 with a seated virtual ATD 206, where each structure has adopted location, initial velocity, deformation, and stresses associated with the simulated acceleration that was applied to each of the first and second numerical simulations 200b, 300b.

FIG. 4B shows the evolution of the computer numerical simulation shown in FIG. 4A after the application of acceleration to the seating assemblies 202, 204, including the effects of impact of the virtual ATD 206 on the first seating assembly 202. The combined numerical simulation 400a differs from, e.g., a complete numerical simulation of a total seating arrangement like 100a (FIG. 1) in that the initial configuration of the combined numerical assembly is configured in such a way that running the combined numerical simulation would result in an imminent impact. Thus, the combined numerical simulation 300a has the technical advantage of being able to simulate the period of time during which the entire seating arrangement must be modeled simultaneously (i.e., impact), but without incurring the processing costs of simultaneously simulating the movements, stresses, and deformation of model elements that are not mechanically linked prior to impact.

Given constraints and initial positions that match those of a complete computer numerical simulation modeling a totality of the seating arrangement, the final state of the combined numerical simulation 400b can closely mimic or be functionally identical to the outcome of a numerical simulation that contains all of the analogous elements from start to finish. However, the first and second partial numerical simulations 200b, 300b (or similar partial numerical simulations) can be reused and recombined into a variety of combined numerical simulations, and obviate the need to reprocess the portions of the simulation that occur more than a short time before impact.

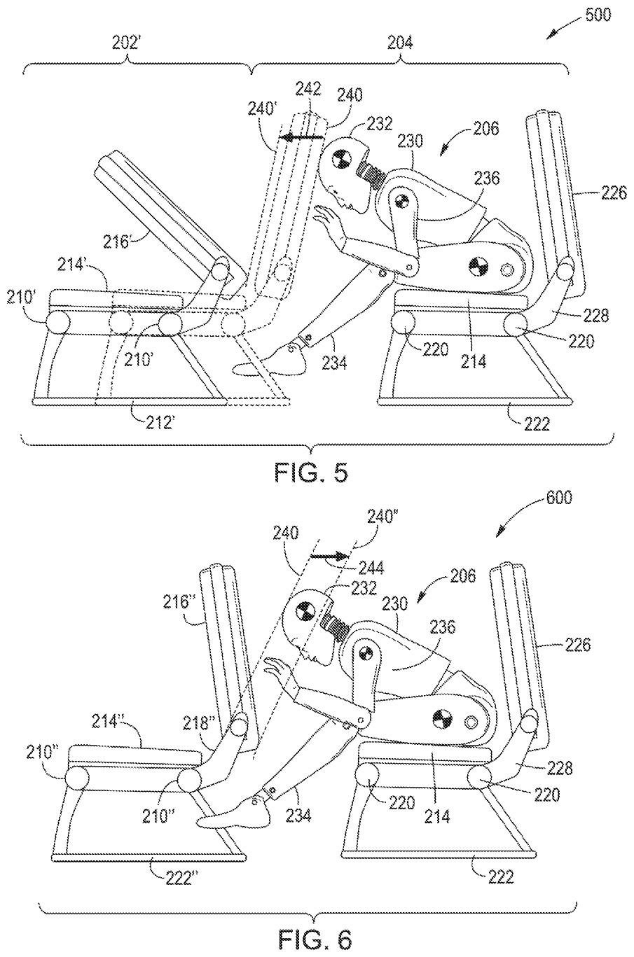

For example, as shown in FIG. 5, an alternative combined numerical simulation 500 can be assembled based on existing partial numerical simulations 200b, 300b to form, e.g., a combined numerical simulation having an extended distance 242 between the second seating assembly 204 and a translated first seating assembly 202′. In the translated first seating assembly 202′, similar components can be present and identically translated, including base 212′, frame tubes 210′, spreaders 218′, seat bottom 214′, seat back 216′. The translated first seating assembly 202′ can define a new virtual position 240′ that is offset from the previously defined virtual position 240.

According to some embodiments, the alternative numerical simulation 500 can be run based on the same state data described above, i.e., state data based on the elapsed period of time corresponding to the first virtual position 240. Although this approach results in some additional time before impact, compared to other methods, the approach still obviates the need to reprocess most of the movements, stresses, and deformation leading up to impact. Alternatively, the alternative numerical simulation 500 can be run based on state data captured from a different elapsed time with respect to the existing, partial numerical simulations 200b, 300b. For example, the period of time can be recalculated based on the time required for interaction between the virtual ADT 206 and the new virtual position 240′, or other suitable benchmark.

As shown in FIG. 6, additional numerical simulations can be generated based on other distances or orientations. FIG. 6 shows an alternative numerical simulation 600 in which existing partial numerical simulations 200b, 300b have been assembled to form a combined numerical simulation in which the distance between seating assemblies is less than that of the original, combined numerical simulation by translating the first seating assembly 202″ by a distance 244 toward the second seating assembly 202. The translated first seating assembly 202″ can, similarly, include base 212″, frame tubes 210″, spreaders 218″, seat bottom 214″, and seat back 216″ that retain their relative positions with respect to each other.

According to some embodiments, the alternative numerical simulation 600 can be run based on the same state data described above, i.e., state data based on the elapsed period of time corresponding to the first virtual position 240. In embodiments where the first virtual position 240 is significantly different than the position of the seat back 216″ at the previously defined elapsed period of time, no additional correction may be needed. However, in some embodiments, this approach may result in some clipping, which can be prevented by, e.g., capturing state data of the partial numerical simulations 200b, 200b based on a different elapsed time. For example, the period of time can be recalculated based on the time required for interaction between the virtual ADT 206 and the new virtual position 240″, or other suitable benchmark, or may be reduced by a predefined increment.

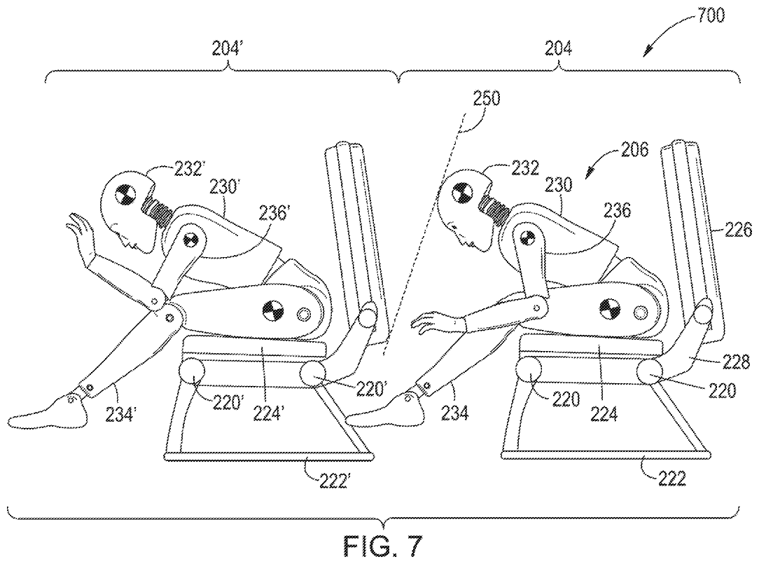

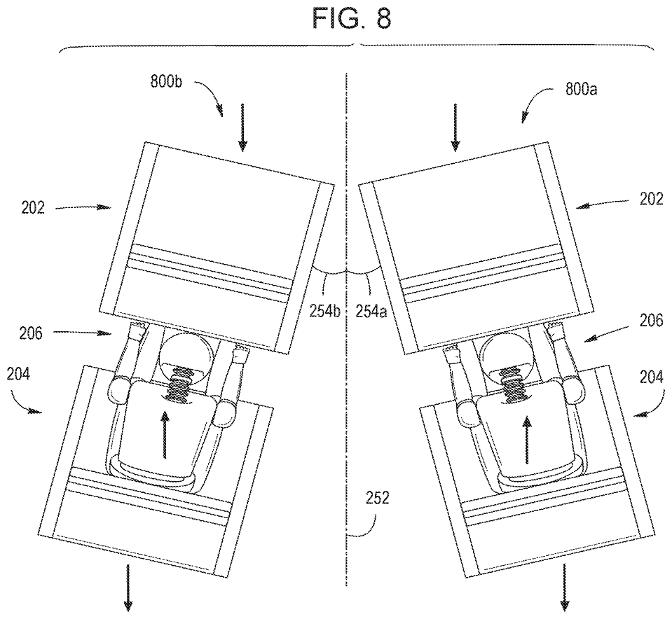

Partial numerical simulations can also be implemented in other arrangements, such as by assembly in combined numerical simulations with computer models of alternative seating assemblies (e.g., seats of different sizes, classes, or builds), or alternative occupancy (e.g. adjacent seats containing virtual passengers, adjacent seats not containing virtual passengers, or alternative models of virtual passengers or virtual ADTs). For example, FIG. 7 shows an example of a computer numerical simulation 700 that includes two iterations of the second partial numerical simulation 300b that includes a virtual ADT 206, whereby a second seating assembly 204 is positioned aft of a translated iteration of the second seating assembly 204′, each seating assembly 204, 204′ including corresponding elements. According to some embodiments, a virtual position 250 can be selected as a basis to set an elapsed time for the capture of state data from the partial numerical simulations (e.g., 300b) from which the combined numerical simulation 700 is assembled, similar to virtual position 240.

Any suitable number of permutations of distance between the seating assemblies 202, 204, relative orientations of the seating assemblies, or orientations of the entire seating arrangement (e.g., tilting, pitch, yaw, roll) can be modeled based on the partial numerical simulations (200b, 300b) or variations thereof without recalculating the partial numerical simulations, thus permitting assembly of a wide variety of combined numerical simulations that can closely approximate complete numerical simulations while obviating a substantial portion of the processing that may otherwise be required. By way of example, a spread of combined numerical simulations can be used to simulate impact based on seat separations that vary by at least +/−7.5 cm (3″), or more; or to simulate impact based on seat angles corresponding to any one of, or any suitable combination of yaw, pitch, and roll ranging from at least +/−10 degrees, or more. FIG. 8 illustrates, in a pair of schematic top views 800a, 800b, how a set of partial numerical simulations can be initialized at varying yaw angles 254a, 254b about a reference axis 252 that is aligned with a direction of a simulated deceleration event. In each view 800a, 800b, the first seating assembly 202 is positioned in front of the virtual passenger/ADT 206 and second seating assembly 204 when the combined simulation is initialized. According to some embodiments, the same partial numerical simulations can be used to generate combined numerical simulations across a variety of angles and configurations. Alternative, according to some embodiments, alternative partial numerical simulations can be generated that take a non-zero angle into account prior to recombination.

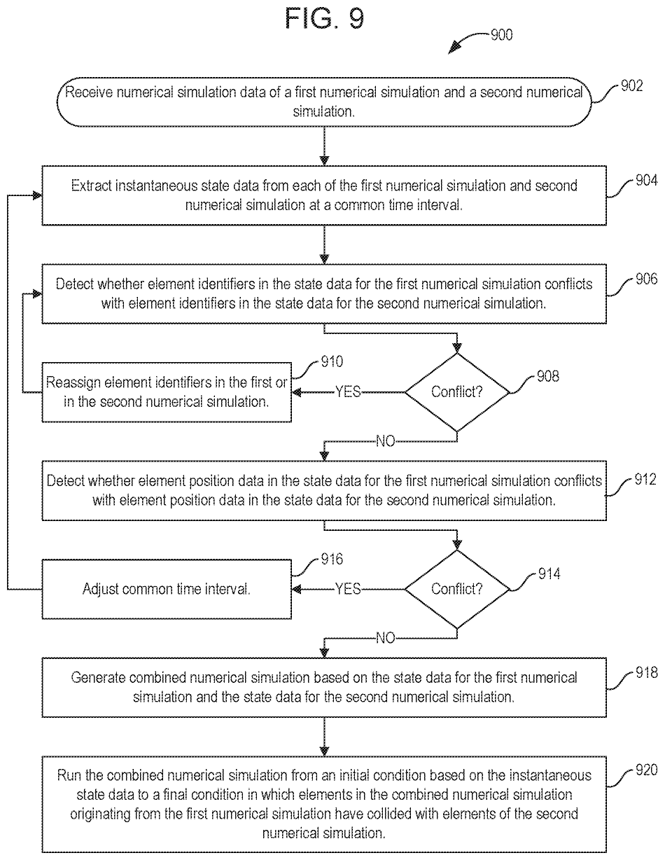

FIGS. 9-11 illustrate various examples of processes for generating combined numerical simulations based on partial numerical simulations or captured state data from partial numerical simulations, in accordance with the various embodiments described above with reference to FIGS. 2-8. Some or all of the processes 900, 1000, 1100 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. In addition, aspects of processes 900, 1000, and 1100 may be used in conjunction with each other, except where clearly contraindicated.

FIG. 9 illustrates a first process 900 for generating combined numerical simulations based on partial numerical simulations or captured state data from partial numerical simulations, in accordance with various embodiments of the present disclosure, and in conjunction with a computing system or systems. The system can receive numerical simulation data of a first numerical simulation and a second numerical simulation. (act 902) This can include generating the first and second numerical simulation and capturing state data at a particular point in time, or receiving simulation data covering a duration of time, or receiving a “snapshot” containing simulation data at a particular point in time. The system can then extract instantaneous state data from each of the first numerical simulation and second numerical simulation at a common time interval. (act 904)

In some embodiments, as where the partial numerical simulations were prepared without preemptively assigning identifier or position data to prevent conflicts, the system may detect whether element identifiers in the state data for the first numerical simulation conflicts with element identifiers in the state data for the second numerical simulation. (act 906) If a conflict exists (act 908), the system may reassign element identifiers and/or element positions in the first or in the second numerical simulation so as to obviate the conflict. (act 910).

In some embodiments, the system may also detect whether element position data in the state data for the first numerical simulation conflicts with element position data in the state data for the second numerical simulation. (act 912) This can occur when the selected state data result in overlapping positions of elements (e.g., seating assemblies modeled too close together), or when the selected partial numerical simulations were prepared without assigning deconflicted reference frames (e.g., seating assemblies in the partial numerical simulations located at a common origin). If a conflict is identified (act 914), the system may detect whether the partial numerical simulations have been modeled based on a common reference frame, and translate one or both numerical models to compensate. If the conflict is identified but the partial numerical simulations have already been assigned correct positions (i.e., non-overlapping positions of any fixed elements,) the system can correct clipping by, e.g., adjusting the common time interval used to capture state data (act 916) and recapture the partial numerical simulation state data based on the adjusted time interval. This process can be performed iteratively.

The system can then generate combined numerical simulation based on the state data for the first numerical simulation and the state data for the second numerical simulation (act 918) and then run the combined numerical simulation from an initial condition based on the instantaneous state data to a final condition in which elements in the combined numerical simulation originating from the first numerical simulation have collided with elements of the second numerical simulation. (act 920)

In operation, the first run of the combined numerical simulation may cost more processing time than an alternative approach of modeling a complete system from initial conditions to post-impact conditions, due to processing time costs associated with ending the two separate “partial” numerical simulations, assembling and setting conditions for the combined numerical simulation, and running the combined numerical simulation. However, iterated runs of the combined numerical simulation, including variations based on translation or rotation of the elements captured from the partial numerical simulations, consume significantly less processing power than a complete numerical simulation. Thus, after as few as two iterative simulations, the approach of using the combined numerical simulation surpasses the approach of using a complete numerical simulation in speed.

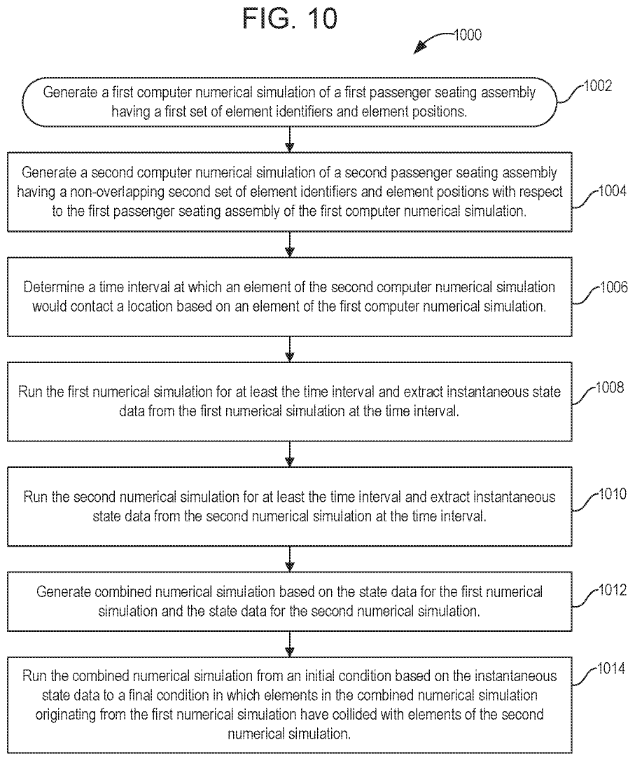

The processes of generating combined numerical simulations can be simplified by preparing partial numerical simulations with specific adjustments for recombination. For example, FIG. 10 illustrates a second process 1000 for generating combined numerical simulations based on partial numerical simulations, in accordance with various embodiments. In process 1000, a computer system can generate a first computer numerical simulation of a first passenger seating assembly having a first set of element identifiers and element positions. (act 1002) The system can then generate a second computer numerical simulation of a second passenger seating assembly having a non-overlapping second set of element identifiers and element positions with respect to the first passenger seating assembly of the first computer numerical simulation. (act 1004) Next, the system can determine a time interval at which an element of the second computer numerical simulation would contact a location based on an element of the first computer numerical simulation. (act 1006) This can include calculating a time interval at which there is intersection between an element of the second partial numerical simulation and location or shape based on the first partial numerical simulation, which may be an initial location or shape of the modeled elements thereof, or may be a final location or shape of the modeled elements thereof.

Following selection of the time interval, the system can run the first numerical simulation for at least the time interval and extract instantaneous state data from the first numerical simulation at the time interval (act 1008), and can run the second numerical simulation for at least the time interval and extract instantaneous state data from the second numerical simulation at the time interval. (act 1010) The system can then generate combined numerical simulation based on the state data for the first numerical simulation and the state data for the second numerical simulation. (act 1012) This combined numerical simulation can be run from an initial condition based on the instantaneous state data to a final condition in which elements in the combined numerical simulation originating from the first numerical simulation have collided with elements of the second numerical simulation. (act 1014)

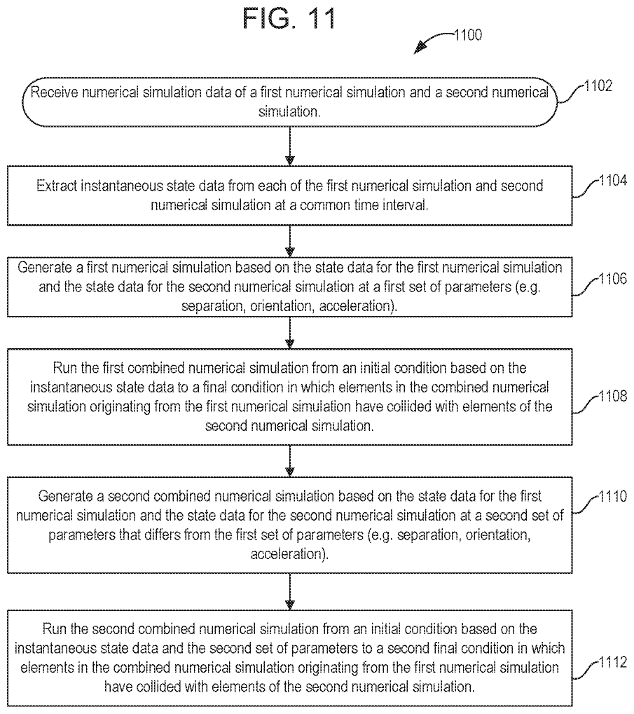

Any of the aforementioned processes 900, 1000 can be implemented iteratively by generating additional combined numerical simulations with varied initial conditions with respect to the relative positioning and orientation of the modeled components selected from the first and second partial numerical simulations, as shown in FIG. 11. FIG. 11 illustrates a process 1100 for iteratively generating combined numerical simulations based on partial numerical simulations, in accordance with various embodiments. Process 1100 can include specific process steps of any of the previously described processes 800, 900. In process 1100, a system can receive numerical simulation data of a first numerical simulation and a second numerical simulation (act 1102) and extract instantaneous state data from each of the first numerical simulation and second numerical simulation at a common time interval. (act 1104) The system can then generate a first numerical simulation based on the state data for the first numerical simulation and the state data for the second numerical simulation at a first set of parameters (e.g. separation, orientation, acceleration) (act 1106), and then run the first combined numerical simulation from an initial condition based on the instantaneous state data to a final condition in which elements in the combined numerical simulation originating from the first numerical simulation have collided with elements of the second numerical simulation. (act 1108)

The system can then iteratively generate additional combined numerical simulations based on the stored state data for the first numerical simulation and second numerical simulation, as follows. The system can generate a second combined numerical simulation based on the state data for the first numerical simulation and the state data for the second numerical simulation at a second set of parameters that differs from the first set of parameters (e.g. separation, orientation, acceleration) (act 1110). According to some embodiments, generating this second combined numerical simulation can include modifying the parameters for selecting state data from the first and second partial numerical simulations (see, e.g., acts 812-816, FIG. 8) so as to prevent positional conflicts between components or to adjust an initial distance between elements in the initial state of the combined numerical simulation. The system can then run the second combined numerical simulation from an initial condition based on the instantaneous state data and the second set of parameters to a second final condition in which elements in the combined numerical simulation originating from the first numerical simulation have collided with elements of the second numerical simulation. (act 1112)

Various computing environments may be used, as appropriate, to implement various embodiments as described herein including web- or cloud-based computing environments, computing environments based on local controllers, or combinations of the above. User or client devices can include any of a number of general purpose personal computers, such as desktop or laptop computers running a standard operating system, as well as devices running mobile software and capable of supporting a number of networking protocols. Such an environment also can include a number of workstations running any of a variety of commercially-available operating systems and other known applications for purposes such as development and database management. These workstations also can include other electronic devices, such as dummy terminals, thin-clients, and other devices capable of communicating via a network and used for communicating with sensors, displays, actuators, and user interfaces, among other devices.

In the following, further examples are described to facilitate the understanding of the invention:

Example A. A computer-implemented method of performing a computational analysis of an impact, the method comprising: modeling, on a computing device, a first numerical simulation representative of a first component; modeling a second numerical simulation representative of a second component; independently running the first numerical simulation and running the second numerical simulation for a nonzero period of time; capturing first simulation data of the first numerical simulation after the period of time; capturing second simulation data of the second numerical simulation after the period of time; generating a combined numerical simulation representative of the first component and the second component, positioned in a first relative orientation and at a first predetermined distance with respect to each other, based on the first simulation data and the second simulation data; and simulating a collision of the first component and the second component by the combined numerical simulation.

Example B. The method of example 1 wherein: the first numerical simulation comprises a first seat in a passenger seating arrangement; the second numerical simulation comprises a second seat in the passenger seating arrangement and a virtual passenger or virtual anthropomorphic test dummy (ATD); and the combined numerical simulation comprises the first seat, virtual passenger or virtual ATD, and the second seat, the second seat and virtual passenger or virtual ADT positioned aft of the first seat and moving forward toward the second seat.

Example C. The method of any of examples 1-2, wherein the nonzero period of time is greater than or equal to a first length of time required for the second component to collide with an initial position of the first component, but less than a second length of time required for the second component to collide with the first component.

Example D. The method of any of examples 1-2, wherein the nonzero period of time corresponds to a length of time required for the second component to collide with an initial position of the first component.

Example E. The method of any of the preceding examples, wherein: the first numerical simulation comprising a first number of connected elements comprising a first plurality of element identifiers; the second numerical simulation comprising a second number of connected elements comprising a second plurality of element identifiers; and the first plurality of element identifiers and the second plurality of element identifiers do not overlap.

Example F. The method of any of examples 1-4, wherein: modifying at least one of a first plurality of element identifiers corresponding to the first numerical simulation, or a second plurality of element identifiers corresponding to the second numerical simulation, to prevent the first plurality of element identifiers and the second plurality of element identifiers from overlapping.

Example G. The method of example any of the preceding examples, wherein an initial state of the combined numerical simulation is representative of the first component and the second component after the first component and the second component have undergone simulated acceleration but prior to collision between the first component and second component.

Example H. The method of any of examples 1-7, further comprising: generating a second combined numerical simulation representative of the first component and the second component, positioned at a second predetermined distance with respect to each other that is different from the first predetermined distance, based on the first simulation data and the second simulation data.

Example I. The method of any of examples 1-7, further comprising: generating a second combined numerical simulation representative of the first component and the second component, positioned in a second orientation that is different than a first orientation of the first component and the second component, based on the first simulation data and the second simulation data.

Example J. The method of any of the preceding examples, wherein: the first simulation data comprises first position, orientation, and velocity data corresponding to a plurality of first elements of the first component; and the second simulation data comprises second position, orientation, and velocity data corresponding to a plurality of second elements of the second component.

Example K. A method comprising: selecting first numerical simulation data, the first numerical simulation data corresponding to a first numerical simulation of a first passenger seat having undergone translation or deformation; selecting second numerical simulation data, the second numerical simulation data corresponding to a second numerical simulation of a second passenger seat and a virtual passenger or virtual anthropomorphic test dummy (ATD) having undergone translation or deformation; modeling, on a computing device, a combined numerical simulation based on the first numerical simulation data and second numerical simulation data, the combined numerical simulation comprising a combined system of the first passenger seat, virtual passenger or virtual ATD, and the second passenger seat, wherein an initial condition of the combined numerical simulations comprises the combined system having undergone translation or deformation.

Example L. The method of example 11, further comprising simulating continued acceleration or deceleration of the combined system in the combined numerical simulation.

Example M. The method of example 11 or example 12, wherein the first numerical simulation data and the second numerical simulation data, respectively, comprise a first end-state of the first numerical simulation and a second end-state of the second numerical simulation resultant from a common acceleration over a common nonzero period of time.

Example N. The method of any of the preceding examples, wherein: in the initial condition of the combined system in the combined numerical simulation, the second passenger seat and virtual passenger or virtual ATD are not in contact with the first passenger seat.

Example O. The method of example 14, wherein: in the initial state in the combined numerical simulation, one of the second passenger seat, or virtual passenger or virtual ATD, is within 5.0 cm, preferably within 2.5 cm, of an initial location of the first passenger seat.

Example P. The method of any of the preceding examples, further comprising: modeling a second combined numerical simulation comprising a second combined system of the first passenger seat, virtual passenger or virtual ATD, and the second passenger seat, wherein the second combined system differs from the combined system by at least one of: a distance between one or more of the first passenger seat, virtual passenger or virtual ATD, and the second passenger seat; an orientation of one or more of the first passenger seat, virtual passenger or virtual ATD, and the second passenger seat; or a configuration of one or more of the first passenger seat, virtual passenger or virtual ATD, and the second passenger seat.

Example Q. The method of any of examples 11-15, further comprising: selecting third numerical simulation data, the third numerical simulation data corresponding to a third numerical simulation of a third passenger seat and second virtual passenger or second virtual ATD; modeling a second combined numerical simulation comprising a second combined system of the third passenger seat, second virtual passenger or second virtual ATD, and the second passenger seat; and simulating acceleration of the second combined system in the second combined numerical simulation.

Example R. A system, comprising: a processor; and at least one memory storing executable instructions that, when executed by the processor, cause the processor to: receive first numerical simulation data corresponding to a first numerical simulation of a first passenger seat having undergone acceleration for a nonzero period of time; receive second numerical simulation data corresponding to a second numerical simulation of a second passenger seat and a virtual passenger or virtual anthropomorphic test dummy (ATD) having undergone acceleration for the nonzero period of time; and generate a third numerical simulation comprising an initial condition comprising representations of the first passenger seat, the virtual passenger or virtual anthropomorphic test dummy (ATD), and the second passenger seat having undergone acceleration for the nonzero period of time.

Example S. The system of example 18, wherein the executable instructions are further configured to cause the processor to simulate continued acceleration of the first passenger seat and the second passenger seat and collision between the first passenger seat and the virtual passenger or virtual ADT.

Example T. The system of example 18, wherein an initial condition of the third numerical simulation comprises: the first passenger seat and virtual passenger or virtual ATD comprising a first set of elements having a first set of positions; and the second passenger seat comprising a second set of elements having a second set of positions, wherein the first set of positions and the second set of positions are non-overlapping.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A computer-implemented method of performing a computational analysis of an impact, the method comprising:
modeling, on a computing device, a first numerical simulation representative of a first seat in a passenger seating arrangement, wherein modeling the first numerical simulation comprises identifying interactions between first physical elements of the first seat;
modeling a second numerical simulation representative of a second seat in the passenger seating arrangement and a virtual body comprising a virtual passenger or virtual anthropomorphic test dummy (ATD), and wherein modeling the second numerical simulation comprises identifying interactions between second physical elements of the second seat and/or the virtual body;
independently running the first numerical simulation and running the second numerical simulation for a nonzero period of time;
capturing first simulation data of the first numerical simulation after the nonzero period of time;
capturing second simulation data of the second numerical simulation after the nonzero period of time;
generating, from the first simulation data and the second simulation data, a combined numerical simulation representative of the first seat and the second sat, wherein the combined numerical simulation models:
(i) the first seat positioned in a first relative orientation and at a first predetermined distance with respect to the second seat, and
(ii) the second seat and the virtual body positioned aft of the first seat and moving forward toward the second seat,
simulating a collision of the first seat with the second seat and/or the virtual body by the combined numerical simulation by simulating collisions between one or more of the first physical elements and one or more of the second physical elements; and
adjusting one or more of the first physical elements or second physical elements based on an output of the combined numerical simulation.

2. (canceled)

3. The method of claim 1, wherein the nonzero period of time is greater than or equal to a first length of time required for the second seat to collide with an initial position of the first seat, but less than a second length of time required for the second a to collide with the first seat.

4. The method of claim 1, wherein the nonzero period of time corresponds to a length of time required for the second seat to collide with an initial position of the first seat.

5. The method of any of claim 1, wherein:
the first physical elements are associated with a first plurality of element identifiers;
the second physical elements are associated with a second plurality of element identifiers; and
the first plurality of element identifiers and the second plurality of element identifiers do not overlap.

6. The method of claim 1, wherein:
modifying at least one of a first plurality of element identifiers corresponding to the first physical elements, or a second plurality of element identifiers corresponding to the second physical elements, to prevent the first plurality of element identifiers and the second plurality of element identifiers from overlapping.

7. The method of claim 1, wherein an initial state of the combined numerical simulation is representative of the first seat and the second seat after the first seat and the second seat have undergone simulated acceleration but prior to collision between the first seat and second seat.

8. The method of claim 1, further comprising:
generating, based on the first simulation data and the second simulation data, a second combined numerical simulation representative of the first seat and the second seat, wherein the first seat and the second seat are positioned at a second predetermined distance with respect to each other that is different from the first predetermined distance.

9. The method of claim 1, further comprising:
generating, based on the first simulation data and the second simulation data, a second combined numerical simulation representative of the first seat and the second seat, wherein the first seat and the second seat are positioned in a second orientation that is different than the first relative orientation.

10. The method of claim 1, wherein:
the first simulation data comprises first position, orientation, and velocity data corresponding the first physical elements of the first seat; and
the second simulation data comprises second position, orientation, and velocity data corresponding the second physical elements of the second seat.

11. A method comprising:
selecting first numerical simulation data, the first numerical simulation data corresponding to a first numerical simulation of a first passenger seat in a passenger seating arrangement, the first passenger seat having undergone translation or deformation;
selecting second numerical simulation data, the second numerical simulation data corresponding to (i) a second numerical simulation of a second passenger seat in the passenger seating arrangement and (ii) a virtual passenger or a virtual anthropomorphic test dummy (ATD) having undergone translation or deformation;
modeling, on a computing device, a combined numerical simulation based on the first numerical simulation data and second numerical simulation data, the combined numerical simulation comprising a combined system of the first passenger seat, virtual passenger or virtual ATD, and the second passenger seat, wherein an initial condition of the combined numerical simulations comprises the combined system having undergone translation or deformation, and wherein the combined numerical simulation models:
(i) the first passenger seat positioned in a first relative orientation and at a first predetermined distance with respect to the second seat, and
(ii) the second passenger seat and virtual passenger or virtual ATD positioned aft of the first seat; and
adjusting, on the computing device, one or more physical elements corresponding to the first passenger seat or the second passenger seat.

12. The method of claim 11, further comprising simulating continued acceleration or deceleration of the combined system in the combined numerical simulation.

13. The method of claim 11, wherein the first numerical simulation data and the second numerical simulation data, respectively, comprise a first end-state of the first numerical simulation and a second end-state of the second numerical simulation resultant from a common acceleration over a common nonzero period of time.

14. The method of claim 11, wherein
the initial condition of the combined system in the combined numerical simulation represents the second passenger seat and virtual passenger or virtual ATD as not in contact with the first passenger seat.

15. The method of claim 14, wherein:
in the initial condition in the combined numerical simulation, the virtual passenger or virtual ATD is positioned within 5.0 cm, preferably within 2.5 cm, of a volume corresponding to an initial location of the first passenger seat.

16. The method of claim 11, further comprising:
modeling a second combined numerical simulation comprising a second combined system of the first passenger seat, virtual passenger or virtual ATD, and the second passenger seat, wherein the second combined system differs from the combined system by at least one of:
a distance between one or more of the first passenger seat, virtual passenger or virtual ATD, and the second passenger seat;
an orientation of one or more of the first passenger seat, virtual passenger or virtual ATD, and the second passenger seat; or
a configuration of one or more of the first passenger seat, virtual passenger or virtual ATD, and the second passenger seat.

17. The method of claim 11, further comprising:
selecting third numerical simulation data, the third numerical simulation data corresponding to a third numerical simulation of a third passenger seat and second virtual passenger or second virtual ATD;
modeling a second combined numerical simulation comprising a second combined system of the third passenger seat, second virtual passenger or second virtual ATD, and the second passenger seat; and
simulating acceleration of the second combined system in the second combined numerical simulation.

18. A system, comprising:
a processor; and
at least one memory storing executable instructions that, when executed by the processor, cause the processor to:
receive first numerical simulation data corresponding to a first numerical simulation of a first passenger seat having undergone acceleration or deceleration for a nonzero period of time, wherein the first numerical simulation data identifies interactions between first physical elements of the first passenger seat;
receive second numerical simulation data corresponding to a second numerical simulation of a second passenger seat and a virtual body comprising a virtual passenger or virtual anthropomorphic test dummy (ATD), the second passenger seat and virtual body having undergone acceleration or deceleration for the nonzero period of time, wherein the second numerical simulation data identifies interactions between second physical elements of the second seat passenger and/or the virtual body;
generate a third numerical simulation comprising an initial condition comprising representations of physical elements of the first passenger seat, the virtual body, and the second passenger seat, wherein the first passenger seat, the second passenger seat, and the virtual body having undergone acceleration or deceleration for the nonzero period of time, wherein the third numerical simulation comprises simulating collisions between one or more of the first physical elements and one or more of the second physical elements; and
adjust one or more of the first physical elements or second physical elements based on an output of the third numerical simulation.

19. The system of claim 18, wherein the executable instructions are further configured to cause the processor to simulate continued acceleration or deceleration of the first passenger seat and the second passenger seat and collision between the first passenger seat and the virtual body.

20. The system of claim 18, wherein an initial condition of the third numerical simulation comprises:
the first passenger seat and virtual body comprising a first set of the physical elements having a first set of positions; and
the second passenger seat comprising a second set of the physical elements having a second set of positions, wherein the first set of positions and the second set of positions are non-overlapping.
